(19) United States
(12) Patent Application Publication
(10) Pub. No.: US 2026/0309500 A1
(43) Pub. Date: Oct. 8, 2026

(54) INFORMATION PROCESSING METHOD, INFORMATION PROCESSING DEVICE, AND COMPUTER PROGRAM

(71) Applicant: Sony Group Corporation, Tokyo (JP)

(72) Inventor: Junichiro TAMAGAWA, Tokyo (JP)

(73) Assignee: Sony Group Corporation, Tokyo (JP)

(21) Appl. No.: 19/483,864

(22) PCT Filed: Apr. 17, 2024
(86) PCT No.: PCT/JP2024/015233

§ 371 Date: Nov. 12, 2025

(30) Foreign Application Priority Data
Jun. 1, 2023 (JP) 2023-091048

(51) Int. Cl. G01C 21/20; G05D 1/229; G05D 109/25

(52) U.S. Cl. CPC G01C 21/20; G05D 1/229; G05D 2109/254

(57) ABSTRACT

A moving body that has moved to a certain position is simply, accurately, and safely returned to a desired position. In one embodiment, a movement route recording step of recording a moved route until a drone reaches the current position, a return designation position determination step of determining a return designation position between the start point of the moved route and the current position of the drone, and a return route generation step of setting the current position of the drone in the moved route as a return reference position and generating a return route for causing the drone to move a portion from the return reference position to the return designation position in the moved route are performed.

### TECHNICAL FIELD

The present disclosure relates to an information processing method, an information processing device, and a computer program.

### BACKGROUND ART

Autonomous moving bodies such as drones are being used in various fields. Drones are already used for applications such as aerial photographing, surveying, inspection, photogrammetry (three-dimensional model generation), and disaster relief.

The drone can perform flight by manual operation, automated flight, or autonomous flight. In the manual operation, for example, the user operates the operation terminal to control the movement of the drone. In the automated flight or the autonomous flight, basically, the operation of the user is not involved in the movement control of the drone. The automated flight here means, for example, that the drone automatically flies along a predetermined flight plan route. The autonomous flight means, for example, that the drone flies according to a predetermined flight plan route while recognizing a space, an obstacle, and the like. In the autonomous flight, for example, a collision between a drone and an obstacle or the like can be avoided.

Common drones can capture images during flight. Then, the drone can transmit the captured image to an external device. For example, the inspection using the drone can be performed on the basis of an image captured by the drone during flight by the manual operation, during the automated flight, or during the autonomous flight.

For example, in the inspection using the drone as described above, there may be a situation in which, for example, a place suspected of being damaged appears in an image captured by the drone during flight, and it is desired to image the place again. At this time, currently, the pilot returns the drone to a position where re-imaging is desired with keeping the manual operation in the case of the manual operation and after switching to the manual operation in the case of the automated flight or the autonomous flight.

However, the operation of returning the drone to a desired position by the manual operation takes time and effort, and may lack accuracy, which is inefficient.

### CITATION LIST

### Patent Document

Patent Document 1: Japanese Patent Application Laid-Open No. 2020-191523

### SUMMARY OF THE INVENTION

### Problems to be Solved by the Invention

The present disclosure has been made in view of the above circumstances, and provides an information processing method, an information processing method, and a computer program capable of easily, accurately, and safely returning a moving body having moved to a certain position to a desired position.

### Solutions to Problems

An information processing method of the present disclosure includes: a movement route recording step of recording a moved route until a moving body reaches a current position; a return designation position determination step of determining a return designation position between a start point of the moved route and the current position of the moving body; and a return route generation step of setting the current position of the moving body in the moved route as a return reference position and generating a return route for causing the moving body to move a portion from the return reference position to the return designation position in the moved route.

An information processing device of the present disclosure includes: a movement route recording unit of recording a moved route until a moving body reaches a current position; a return designation position determination unit of determining a return designation position between a start point of the moved route and the current position of the moving body; and a return route generation unit of setting the current position of the moving body in the moved route as a return reference position and generating a return route for causing the moving body to move a portion from the return reference position to the return designation position in the moved route.

A computer program of the present disclosure causes a computer to execute: a movement route recording step of recording a moved route until a moving body reaches a current position; a return designation position determination step of determining a return designation position between a start point of the moved route and the current position of the moving body; and a return route generation step of setting the current position of the moving body in the moved route as a return reference position and generating a return route for causing the moving body to move a portion from the return reference position to the return designation position in the moved route.

### BRIEF DESCRIPTION OF DRAWINGS

FIG. 1 is a diagram schematically illustrating an information processing system according to an embodiment including a drone as a moving body.

FIG. 2 is a block diagram illustrating functional configurations of a drone, a controller, and a cloud server constituting the information processing system according to the embodiment.

FIG. 3 is a diagram illustrating a detailed functional configuration of a route planning unit in the controller illustrated in FIG. 2.

FIG. 4 is a diagram conceptually illustrating a relationship between an image captured by a drone and a moved route of the drone, which are recorded in the information processing system.

FIG. 5 is a flowchart illustrating an example of processing of the information processing system according to the embodiment.

FIG. 6 is a diagram for explaining an example of an operation state of a drone controlled by the processing of FIG. 5, in which FIG. 6(A) is a bird's-eye view of the operation state of the drone, and FIG. 6(B) is a diagram of the operation state of the drone as viewed from above.

FIG. 7 is a diagram for explaining an example of an operation state of a drone controlled by the processing of FIG. 5, in which FIG. 7(A) is a bird's-eye view of the operation state of the drone, and FIG. 7(B) is a diagram of the operation state of the drone as viewed from above.

FIG. 8 is a diagram for explaining an example of an operation state of a drone controlled by the processing of FIG. 5, in which FIG. 8(A) is a bird's-eye view of the operation state of the drone, and FIG. 8(B) is a diagram of the operation state of the drone as viewed from above.

FIG. 9 is a diagram illustrating an example of an interface used by the user for a part of the processing of FIG. 5 (step S508: determination operation of a return designation position).

FIG. 10 is a diagram illustrating a state in which the drone is moved from the state of the drone in FIG. 8.

FIG. 11 is a diagram for explaining an example of an operation of returning the drone in the state illustrated in FIG. 10 to a predetermined route.

FIG. 12 is a diagram for explaining an example of an operation of returning the drone in the state illustrated in FIG. 10 to a predetermined route.

FIG. 13 is a diagram for explaining an example of an operation of returning the drone in the state illustrated in FIG. 10 to a predetermined route.

FIG. 14 is a diagram for explaining an example of an operation of returning the drone in the state illustrated in FIG. 10 to a predetermined route.

FIG. 15 is a diagram illustrating an example of a hardware configuration of an information processing device that can constitute a drone and a controller constituting the information processing system according to the embodiment.

### MODE FOR CARRYING OUT THE INVENTION

Hereinafter, an embodiment of the present disclosure will be described with reference to the drawings.

### Information Processing System

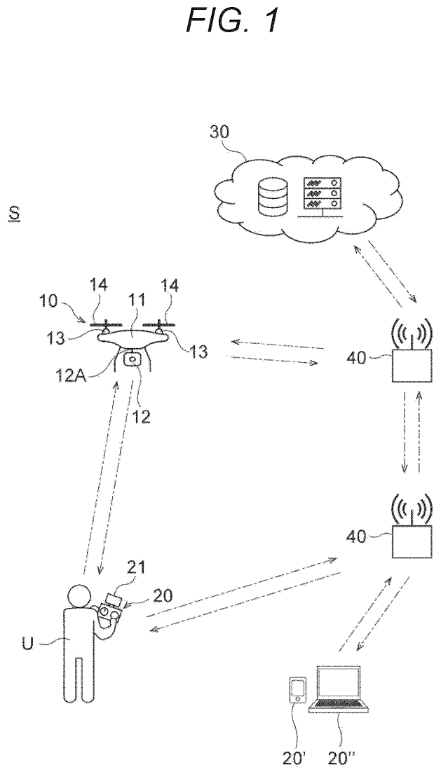

FIG. 1 schematically illustrates an information processing system S according to an embodiment. In this example, the information processing system S includes a drone 10 as a moving body, a controller 20 operated by a user U for controlling the drone 10, and a cloud server 30. Note that in a case of being simply referred to as a drone, this term means an unmanned flying object.

The drone 10 includes an airframe 11 holding various control components and instruments, an imaging device 12, a plurality of motors 13, and a plurality of propellers 14. The airframe 11 supports the imaging device 12, the motors 13, and the propellers 14. The imaging device 12 is supported by the airframe 11 via a gimbal 12A. The imaging device 12 captures images around the drone 10 and can change the imaging direction by controlling the gimbal 12A. The motor 13 drives the propeller 14.

In the information processing system S, the drone 10 and the controller 20 can perform bidirectional wireless communication. Furthermore, in the information processing system S, the drone 10 and the cloud server 30 can also perform bidirectional wireless communication.

The drone 10 can be controlled with a manual operation by the controller 20. In the manual operation, the drone 10 receives a control command based on the intention of the user, the control command being transmitted from the controller 20, for example, and is controlled on the basis of the control command. The control command is generated, for example, by a user directly operating the controller 20. For example, in a case where the control command is a command related to flight, the drone 10 controls driving of the propeller 14 via the motor 13 on the basis of the control command.

Furthermore, the drone 10 can also perform automated flight (automated movement) and autonomous flight (autonomous movement) In the automated flight, the drone 10 generates a flight plan route (movement plan route) by itself or receives a flight plan route from the controller 20, for example, and flies according to the flight plan route. In the autonomous flight, the drone 10 generates a flight plan route (movement plan route) by itself or receives a flight plan route from the controller 20, for example, and autonomously flies according to the flight plan route.

“Autonomous flight” described above means that, for example, the drone 10 performs flight according to a flight plan route or performs flight while generating a flight plan route while recognizing a space, an obstacle, a subject, and the like, for example, avoiding a collision, and maintaining a relative distance to the subject within a predetermined condition.

The drone 10 can capture an image by the imaging device 12 during various flights as described above. At this time, the imaging direction of the imaging device 12 can be controlled by controlling the gimbal 12A according to a control command from the controller 20. Furthermore, in the present embodiment, the imaging device 12 also has a thermal camera function, so that the drone 10 also obtains temperature information of a region in the image.

Then, the drone 10 can transmit an image being captured, temperature information of an area in the image, the current position, and the like to the controller 20. Furthermore, as described above, the drone 10 and the cloud server 30 can perform bidirectional wireless communication. As a result, the drone 10 can also transmit, for example, an image being captured, temperature information of an area in the image, the current position, and the like to the cloud server 30.

FIG. 1 illustrates a plurality of base stations 40. When the drone 10 and the cloud server 30 perform bidirectional wireless communication, one or a plurality of base stations 40 is interposed as indicated by a two-dot chain line arrow in FIG. 1. Furthermore, the controller 20 can also transmit a control command to the drone 10 via one or a plurality of base stations 40 as indicated by a two-dot chain line arrow in FIG. 1. In a case where the drone 10 is operated from a remote place or in a case where the drone 10 is caused to fly out of sight, the drone 10 may be controlled via the base station 40.

The controller 20 in the present embodiment is an operation-dedicated device gripped by the user U and including an antenna that transmits the control command. Reference sign 21 in FIG. 1 denotes a display 21 provided in the controller 20. The display 21 can display, for example, an image captured by the drone 10. Note that the controller 20 may include, for example, a tablet 20′ (including a smartphone) or a personal computer 20″ illustrated in FIG. 1. For example, in a case where the controller 20 communicates with the drone 10 via the base station 40, or in a case where the tablet 20′ (including a smartphone) or the personal computer 20″ functions as the controller 20 and communicates with the drone 10, the bidirectional communication may be performed via a network such as the Internet by a communication method such as Bluetooth (registered trademark) or Wifi.

Note that, in the present specification, for example, the expression of transmitting or receiving an image or a position means accurately transmitting or receiving information of an image or information of a position as electronic information. In the present specification, the information transmitted and received between the drone 10 and the controller 20, the information transmitted and received between the drone 10 and the cloud server 30, and the information transferred inside the drone 10 and the controller 20 mean electronic information even in a case where the information is not specified by the expression including the term information.

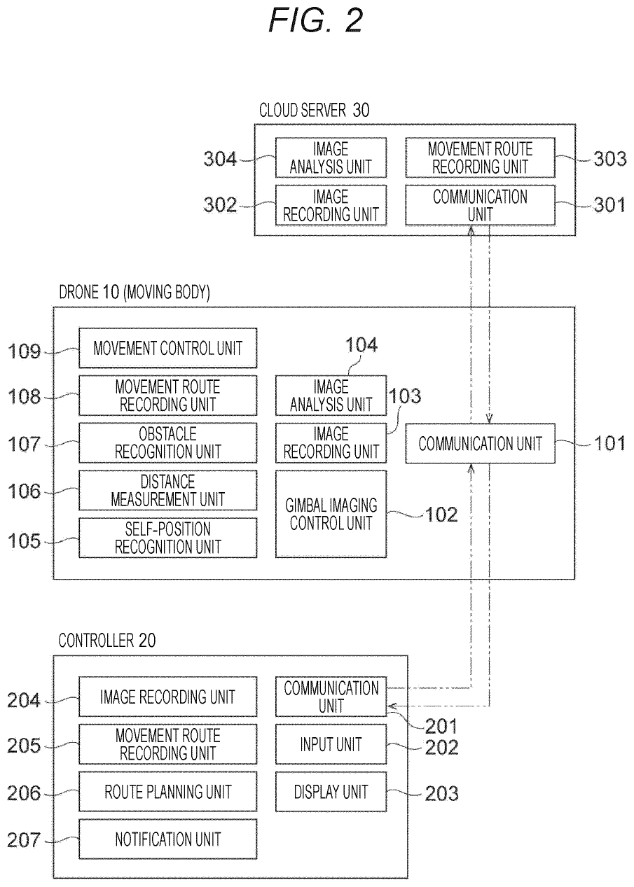

FIG. 2 is a block diagram illustrating a functional configuration of the drone 10, the controller 20, and the cloud server 30. Hereinafter, the drone 10, the controller 20, and the cloud server 30 will be described in detail.

### (Drone)

The drone 10 includes a communication unit 101, a gimbal imaging control unit 102, an image recording unit 103, an image analysis unit 104, a self-position recognition unit 105, a distance measurement unit 106, an obstacle recognition unit 107, a movement route recording unit 108, and a movement control unit 109.

The communication unit 101 communicates with the controller 20 and/or the cloud server 30 via an antenna. Specifically, the communication between the communication unit 101 and the cloud server 30 is performed via the base station 40. The communication unit 101 transmits, for example, the position of the drone 10, an image captured by the drone 10 with the imaging device 12, and the like to the controller 20 and/or the cloud server 30. The position of the drone 10 is information calculated by the self-position recognition unit 105 to be described later, and includes at least a traveling direction, latitude, longitude, and altitude of the drone 10.

Meanwhile, the communication unit 101 receives a control command related to flight and imaging, a flight plan route for automated flight or autonomous flight, and the like from the controller 20. Note that the control command and the flight plan route from the controller 20 can also be transmitted to the drone 10 via the cloud server 30.

A communication method of the communication unit 101 may be optional. As an example, the communication method may be based on the IEEE 802.11 standard, the IEEE 802.15.1 standard (Bluetooth (registered trademark)), an OFDM modulation scheme, or other standards. The frequency band to be used for wireless communication may be a 2.4 GHz band, a 5 GHz band, or other frequency bands, for example.

The gimbal imaging control unit 102 controls the imaging device 12 and the gimbal 12A. Specifically, the gimbal imaging control unit 102 controls imaging conditions (zoom, focus, exposure, shutter speed, white balance, ISO, aperture, and the like) and an imaging direction of the imaging device 12 to desired conditions. The gimbal imaging control unit 102 may control the imaging device 12 and the gimbal 12A on the basis of a control command transmitted from the controller 20 or the like, or may autonomously control the imaging device 12 and the gimbal 12A.

The gimbal imaging control unit 102 provides an image captured by the imaging device 12 and angle information (pitch/yaw/roll) of the gimbal 12A when the image is captured to the communication unit 101 and/or the image recording unit 103. The communication unit 101 transmits the provided image and the angle information of the gimbal 12A to the controller 20 and/or the cloud server 30. Note that the imaging device 12 basically captures a moving image at a predetermined frame rate. The moving image includes a plurality of continuously captured images. Note that, in a case of simply being referred to as an image, this means a still image.

Furthermore, in the present embodiment, as described above, the imaging device 12 also has a thermal camera function, so that temperature information of a region in the image can be also obtained. This temperature information is also provided to the communication unit 101 and/or the image recording unit 103.

The image recording unit 103 records an image and angle information of the gimbal 12A associated with the image provided from the gimbal imaging control unit 102. Furthermore, the image recording unit 103 may record temperature information of an area in the image in association with the image together with recording of the image. Then, the image recording unit 103 provides, to the image analysis unit 104, at least the image and the temperature information of the area of the image provided from the gimbal imaging control unit 102.

The image analysis unit 104 detects an error in the image provided from the image recording unit 103. Specifically, the image analysis unit 104 detects an error in a case where an image that does not satisfy a predetermined imaging condition occurs in a plurality of continuously captured images. Errors in the image include, for example, a case where the image is not captured with an appropriate focus, a case where the image is not captured with an appropriate exposure, a case where the image is not captured appropriately, and the like, and it is determined whether or not an error occurs by comparison with the respective reference values. Furthermore, the image analysis unit 104 also detects whether or not a predetermined detection target exists in a plurality of continuously captured images. The detection target is determined in advance by the user, and may be, for example, rust, a scratch, or the like on a structure that is a subject being imaged. Furthermore, the image analysis unit 104 can detect an abnormal temperature region of a predetermined temperature or higher on the basis of the temperature information of the image.

As described above, in a case where the image analysis unit 104 detects at least one of an image error, a detection target, or an abnormal temperature region, in the present embodiment, the image analysis unit 104 generates a stop signal and provides the stop signal to the movement control unit 109 described later. In response to the stop signal, the movement control unit 109 controls the drone 10 to be in a temporary stop state (hovering state). Furthermore, information on at least one of an image error, a detection target, or an abnormal temperature region detected by the image analysis unit 104 is transmitted to the controller 20 via the communication unit 101. As will be described later, on the basis of the above-described information from the image analysis unit 104, the controller 20 notifies the user to prompt the user to return the drone 10 to a position where an image error or the like has occurred. In a case where the drone 10 is returned by using this notification as a trigger, for example, an image to be acquired can be appropriately acquired.

The self-position recognition unit 105 includes various sensors for detecting the position of the drone 10. In the present embodiment, the self-position recognition unit 105 includes, for example, a geomagnetic sensor, a barometric pressure sensor, and a GNSS reception unit as the various sensors. The self-position recognition unit 105 recognizes the traveling direction, latitude, longitude, and altitude of the drone 10 as the position of the drone 10, and provides these pieces of information to the communication unit 101, the obstacle recognition unit 107, the movement route recording unit 108, and the movement control unit 109.

The geomagnetic sensor measures the traveling direction of the drone 10 through measurement of the geomagnetism. The barometric pressure sensor measures barometric pressure. The barometric pressure varies depending on the height from the ground surface. Therefore, the altitude of the drone 10 can be calculated on the basis of the barometric pressure measured by the barometric pressure sensor. The GNSS reception unit receives a signal from a GPS satellite or another satellite (for example, Galileo or QZSS), and detects the current position (latitude, longitude, altitude) of the drone 10 on the basis of the received signal.

The distance measurement unit 106 includes any one of a stereo camera, a Lidar sensor, a ToF sensor, an infrared sensor, an ultrasonic sensor, and a monocular camera for detecting an obstacle around the drone 10, or a combination of two or more thereof. Furthermore, the distance measurement unit 106 may be configured by further incorporating an inertial measurement unit (IMU) in any one or a combination of these sensors. The distance measurement unit 106 provides information on the distance between the drone 10 and the obstacle existing around the drone 10 to the obstacle recognition unit 107. Note that the obstacles refer to potential obstacles to the flight of the drone 10, including such as flying objects other than the drone 10, buildings, trees, people, vehicles, ground surfaces, mountain surfaces, and water surfaces.

The stereo camera captures images around the drone 10 with two or more imaging units, and acquires two or more image signals different from each other. The two or more image signals are used to detect the distance from the drone 10 to the object on the captured image. A light detection and ranging (LiDAR) sensor, a time of flight (TOF) sensor, and an infrared sensor measure the distance from the drone 10 to the obstacle in the time until reflected light returns after emitting the light. The ultrasonic sensor generates an ultrasonic wave and measures the distance from the drone 10 to the obstacle in the time until the reflected ultrasonic wave returns. The monocular camera measures the distance from the drone 10 to the obstacle on the basis of, for example, a focus shift between subjects.

The IMU includes, for example, a three-axis gyro sensor and a three-direction acceleration sensor, and measures the angular velocity and the acceleration of the drone 10. On the basis of the information of the angular velocity and the acceleration of the drone 10 measured by the IMU, the measurement accuracy of the distance can be improved by correcting the irradiation angle of light in the LiDAR or the like, for example. The information detected by the IMU is also provided to the movement control unit 109.

The obstacle recognition unit 107 specifies a relative positional relationship between the drone 10 and the obstacle on the basis of the information on the distance from the drone 10 to the obstacle provided from the distance measurement unit 106. The obstacle recognition unit 107 provides the relative positional relationship between the drone 10 and the obstacle to the movement control unit 109.

The movement route recording unit 108 records the traveling direction, latitude, longitude, and altitude of the drone 10 provided from the self-position recognition unit 105. According to the information of the position of the drone 10 recorded in the movement route recording unit 108, the moved route from the departure to the current position of the drone 10 can be recorded and specified. Note that the point from which the drone 10 has departed corresponds to the start point of the moved route.

The movement control unit 109 is what is called a flight controller, and controls the flight state of the drone 10 by controlling the motor 13 and the propeller 14. For example, in a case where the drone 10 is manually operated, the movement control unit 109 receives a control command transmitted from the controller 20, for example, and controls the motor 13 and the propeller 14. The movement control unit 109 generates a flight plan route by itself or receives a flight plan route from the controller 20, for example, and controls the motor 13 and the propeller 14 so that the drone 10 automatically or autonomously flies according to the flight plan route in a case where automated or autonomous flight is performed. In a case where autonomous flight is performed, the movement control unit 109 autonomously controls the drone 10 so that the drone does not collide with an obstacle on the basis of the relative positional relationship between the drone 10 and the obstacle provided from the obstacle recognition unit 107.

Furthermore, for example, in a case where a flight plan route when automated flight or autonomous flight is performed is determined in advance, the movement control unit 109 detects whether or not the drone 10 deviates from the predetermined flight plan route by a predetermined distance or more. Then, when detecting deviation of the drone 10 from the flight plan route by a predetermined distance or more, the movement control unit 109 controls the drone 10 to be in a temporary stop state (hovering state). Then, information on deviation from the flight plan route detected by the movement control unit 109 is transmitted to the controller 20 via the communication unit 101. As will be described later, the controller 20 in the present embodiment notifies the user to prompt the user to return the drone 10 to the position before deviation on the basis of the above-described information from the movement control unit 109.

Furthermore, the drone 10 can perform flight according to a predetermined flight plan route or perform autonomous flight of flying while generating a flight plan route while recognizing an object designated by the user, for example, a subject, for example, and while maintaining a relative distance to the object within a predetermined condition. In such an operation state, the movement control unit 109 detects whether or not the relative distance between the drone 10 and the above-described object deviates from a predetermined condition, and controls the drone 10 to be in a temporary stop state (hovering state) when this state is detected. Then, information on abnormality of the relative distance to the object detected by the movement control unit 109 is also transmitted to the controller 20 via the communication unit 101. Upon receiving the information regarding the abnormality of the relative distance to the above-described object from the movement control unit 109, the controller 20 in the present embodiment notifies the user to prompt the user to return the drone 10 to the position where the relative distance to the object is appropriate.

### (Controller)

The controller 20 includes a communication unit 201, an input unit 202, a display unit 203, an image recording unit 204, a movement route recording unit 205, a route planning unit 206, and a notification unit 207.

The communication unit 201 communicates with the drone 10 via an antenna or via an antenna and the base station 40. The communication unit 201 transmits a control command to the drone 10, for example. The communication unit 201 receives, from the drone 10, for example, the position of the drone 10, an image captured by the drone 10 with the imaging device 12, angle information (pitch/yaw/roll) of the gimbal 12A when the image is captured, temperature information of an area in the image, and the like. Furthermore, the communication unit 201 also receives information on an image error, a detection target, and an abnormal temperature region detected by the image analysis unit 104 in the drone 10, information on deviation from a flight plan route detected by the movement control unit 109, and information on abnormality of a relative distance to the object.

The communication method of the communication unit 201 may be optional, and may be the same as or different from the method of the communication unit 101 of the drone 10 as long as communication with the drone 10 can be properly performed.

The input unit 202 is connected to a physical operation unit (a switch, a stick, a touch panel in the display 21, and the like) not illustrated on the controller 20, and detects a user's operation via the operation unit. Then, the input unit 202 generates a command corresponding to the detected operation by the user and provides the command at an appropriate position.

For example, in a case where the user operates the operation unit for manual operation of the drone 10, the input unit 202 generates a control command according to the user's operation, and transmits the control command from the communication unit 201 to the drone 10. Furthermore, in the present embodiment, the user can generate a flight plan route for automated flight or autonomous flight, for example, by using a switch, a stick, or a touch panel while visually recognizing an interface displayed on the display 21, which is not illustrated. At this time, the input unit 202 detects an operation from the user and provides a command according to the operation to the route planning unit 206 to be described later to generate a flight plan route.

The display unit 203 displays an image captured by the drone 10 with the imaging device 12 and a map image on the display 21. The display unit 203 can also display the current position of the drone 10 and the previously moved route in an overlapping manner on the map image. Furthermore, the display unit 203 can also display various types of information such as a warning.

The image recording unit 204 records an image captured by the imaging device 12 in the drone 10, the image being received by the communication unit 201, and angle information (pitch/yaw/roll) of the gimbal 12A when the image is captured. Furthermore, in a case where the communication unit 201 receives the temperature information of the area in the image, the image recording unit 204 may record the temperature information of the area in the image in association with the image together with the recording of the image.

The movement route recording unit 205 records the traveling direction, latitude, longitude, and altitude of the drone 10 received by the communication unit 201. According to the information of the position of the drone 10 recorded in the movement route recording unit 108, the moved route from the departure to the current position of the drone 10 can be recorded and specified.

The route planning unit 206 generates a flight plan route for causing the drone 10 to perform automated flight or autonomous flight. As described above, when the user generates a flight plan route for automated flight or autonomous flight on the controller 20, the input unit 202 detects an operation from the user and provides a command according to the operation to the route planning unit 206. The route planning unit 206 generates a flight plan route by, for example, specifying a target position or providing a command related to route generation. The route planning unit 206 transmits the generated flight plan route from the communication unit 201 to the drone 10.

Furthermore, in a case where the user desires to return the drone 10 from the current position to a certain position, the route planning unit 206 in the present embodiment generates a route (hereinafter, referred to as a return route) for returning the drone 10 from the current position to the certain position on the basis of an instruction from the user. As described above, the communication unit 201 also receives information on an image error, a detection target, and an abnormal temperature region detected by the image analysis unit 104 in the drone 10, information on deviation from a flight plan route detected by the movement control unit 109, and information on abnormality of a relative distance to the object. The controller 20 performs a notification by the notification unit 207 on the basis of these pieces of information. With such a notification, the user is prompted to return the drone 10 to the position where the detection of the above-described information has occurred. After such a notification, in a case where the user gives an instruction to return the drone 10 from the current position to the position where the detection of the above-described information has occurred, the route planning unit 206 generates the above-described return route.

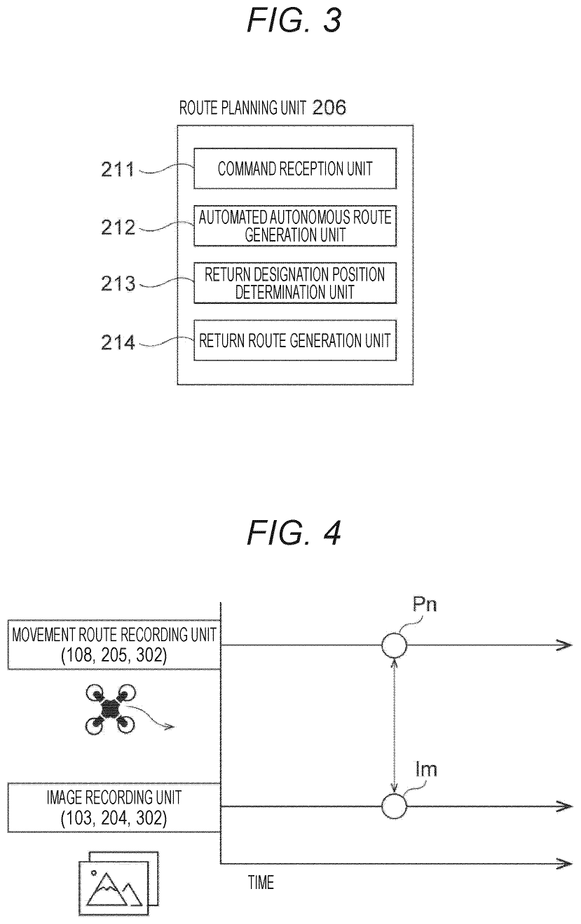

Here, FIG. 3 illustrates detailed functional blocks of the route planning unit 206. The route planning unit 206 includes a command reception unit 211, an automated autonomous route generation unit 212, a return designation position determination unit 213, and a return route generation unit 214.

The command reception unit 211 is provided with a command and information for generating a flight plan route for automated flight or autonomous flight from the input unit 202. Furthermore, the command reception unit 211 is provided with a command and information for generating a return route from the input unit 202.

The automated autonomous route generation unit 212 generates a flight plan route for automated flight or autonomous flight on the basis of a command and information for generating a flight plan route for automated flight or autonomous flight provided to the command reception unit 211. At this time, the automated autonomous route generation unit 212 may acquire three-dimensional map information from the outside and generate a flight plan route in which the drone 10 can avoid a building or the like.

The return designation position determination unit 213 and the return route generation unit 214 generate a return route for returning the drone 10 from the current position to a certain position on the basis of the command and information for generating the return route provided to the command reception unit 211. The return route is generated on the basis of a return reference position, which is the current position of the drone 10, a position designated by the user where the drone 10 is to be returned (hereinafter, a return designation position), and the moved route recorded in the movement route recording unit 205.

In the present embodiment, as an example, an interface that displays the moved route recorded in the movement route recording unit 205 in superposition with the map image and allows the user to designate the above-described return designation position between the start point of the moved route and the current position of the drone 10 from the moved route and an interface that displays the image recorded in the image recording unit 204 so that the image can be rewound and fast-forwarded and allows the user to designate the return designation position by selecting a specific image are provided on the display 21.

The return designation position determination unit 213 determines the return designation position on the basis of the position of the moved route on the map image or the selection of the image designated by the user in the two interfaces described above. The return designation position is determined by selecting an image because the image recorded in the image recording unit 204 is associated with the position where the image is captured. In a case where the return designation position is determined by selecting the image, since the image has been captured at a certain position on the moved route, the determined return designation position is a position on the upstream side (starting point side) of the current position of the drone 10 in the moved route.

Then, when the return designation position is determined by the return designation position determination unit 213, the return route generation unit 214 generates the return route from the return reference position, the return designation position, and the moved route recorded in the movement route recording unit 205. Specifically, the return route generation unit 214 generates the return route on the basis of the portion from the return reference position to the return designation position in the moved route. That is, the generated return route is formed by a portion obtained by cutting out a part of the moved route. Note that the return reference position is specified from the current position of the drone 10, but is not limited to this mode.

The return route generated by the return route generation unit 214 is transmitted to the drone 10 as a flight plan route for automated or autonomous flight. The drone 10 that has received the return route is controlled by the movement control unit 109 and moved to the return designation position according to the return route.

Here, after the drone 10 is moved to the return designation position as described above, in the present embodiment, the command reception unit 211 receives an instruction to move the drone 10 to the return reference position. The instruction of the movement of the drone 10 to the return reference position may be input to the command reception unit 211 by the user operating, for example, a button of the movement instruction displayed on the display 21.

In the present embodiment, in a case where an instruction to move the drone 10 to the return reference position described above occurs, the return route generation unit 214 generates a return route for reference position. At this time, in the present embodiment, the return route generation unit 214 displays a plurality of candidates of return route patterns for reference position on the display 21, generates a return route for reference position corresponding to the return route pattern for reference position selected by the user on the display 21, and transmits the return route for reference position to the drone 10. The drone 10 that has received the return route for reference position is controlled by the movement control unit 109 to be moved to the return reference position.

Examples of the pattern of the return route for reference position described above include a pattern of linearly moving the drone 10 to the return reference position, a pattern of linearly moving the drone 10 to the return designation position, and the like. Details of such a pattern will be described later. Note that the return reference position serving as the end point in the return route for reference position does not need to coincide with the return reference position when the return route is generated. For example, the return reference position at the time of generating the return route is the latest position of the drone 10 at the time of generating the return route, but in a case where imaging is stopped before generating the return route, the position where imaging is stopped may be set as the return reference position to be the end point in the return route for reference position.

Returning to FIG. 2, when the communication unit 201 receives information on an image error, a detection target, and an abnormal temperature region detected by the image analysis unit 104 in the drone 10, information on deviation from a flight plan route detected by the movement control unit 109, and information on abnormality of a relative distance to the object, the notification unit 207 is provided with one or more of these pieces of information. The notification unit 207 performs a notification for prompting the user to return the drone 10 to the position where the detection of the information has occurred on the basis of the information provided from the communication unit 201.

For example, the notification unit 207 may provide a warning display command to the display unit 203 to cause the display 21 to display a warning. The warning display may be light emission or character display. In a case where the characters are displayed, a message to the effect that the drone 10 is temporarily stopped (such as “the drone is temporarily stopped”), a message to the effect that it is recommended to return the drone 10 (such as “it is recommended to return the drone”) may be displayed. Furthermore, the notification unit 207 may perform a notification by generating a warning sound or vibration.

### (Cloud Server)

The cloud server 30 includes a communication unit 301, an image recording unit 302, a movement route recording unit 303, and an image analysis unit 304.

The communication unit 301 communicates with the drone 10 and/or the controller 20. The communication unit 301 transmits a control command generated by the controller 20, a flight plan route, and the like to the drone 10 according to the situation. The communication unit 301 receives, from the drone 10, for example, the position of the drone 10, an image captured by the drone 10 with the imaging device 12, angle information of the gimbal 12A when the image is captured, temperature information of an area in the image, and the like.

The communication method of the communication unit 301 may be optional, and may be the same as or different from the method of the communication unit 101 of the drone 10 as long as communication with the drone 10 and/or the controller 20 can be properly performed.

The image recording unit 302 records an image captured by the imaging device 12 in the drone 10, the image being received by the communication unit 301, and angle information of the gimbal 12A when the image is captured. Furthermore, in a case where the communication unit 301 receives the temperature information of the area in the image, the image recording unit 302 may record the temperature information of the area in the image in association with the image together with the recording of the image.

The movement route recording unit 303 records the traveling direction, latitude, longitude, and altitude of the drone 10 received by the communication unit 301. According to the information of the position of the drone 10 recorded in the movement route recording unit 303, the moved route from the departure to the current position of the drone 10 can be recorded and specified.

The image analysis unit 304 functions similarly to the image analysis unit 104 in the drone 10, and detects an error in the image provided from the image recording unit 302, whether or not a predetermined detection target exists in the image, and an abnormal temperature region in the image. When detecting at least one of an image error, a detection target, or an abnormal temperature region, the image analysis unit 304 may notify the drone 10 and the controller 20 from the cloud server 30. The drone 10 may make a temporary stop in response to this notification, and the controller 20 may perform a notification to prompt the user to return the drone 10. In a case where the image analysis unit 304 is provided in the cloud server 30, the image analysis unit 104 may not be provided in the drone 10. By providing the image analysis unit 304 in the cloud server 30, the processing load of the drone 10 can be reduced.

### (State of Recorded Image and Moved Route)

Hereinafter, the state of the information recorded in the information processing system S will be described in detail. As illustrated in FIG. 2, each of the drone 10, the controller 20, and the cloud server 30 in the information processing system S includes an image recording unit (103, 204, 302) and a movement route recording unit (108, 205, 303), respectively. The image recorded in the image recording unit (103, 204, 302) and the position of the drone 10 recorded in the movement route recording unit (108, 205, 303) are associated at the same time, respectively. In other words, one of the plurality of images recorded in the image recording unit (103, 204, 302) and a certain position of the moved route of the drone 10 recorded in the movement route recording unit (108, 205, 303) are recorded in a state where the timelines are synchronized with each other.

FIG. 4 conceptually illustrates a relationship between an image captured by the drone 10 and recorded in the information processing system S and a moved route of the drone 10. The horizontal axis illustrated in FIG. 4 indicates a time axis. In FIG. 4, the time at which the image recorded in the image recording unit (103, 204, 302) is captured is specified by a time axis. The position of the drone 10 recorded in the movement route recording unit (108, 205, 303) is associated with the time when the drone 10 flies at the position. Therefore, for example, an image Im captured at a position Pn can be specified by specifying the position of the drone 10 indicated by the reference sign Pn in FIG. 4. Furthermore, in the image recording unit (103, 204, 302), angle information of the gimbal 12A associated with the image is recorded together with the image. Therefore, when the image Im is specified, the angle information of the gimbal 12A at that time is also specified, and the imaging condition and the imaging direction are specified.

In the controller 20, the image recorded in the image recording unit 204 is displayed so that the image can be rewound and fast-forwarded as described above, and the display 21 is provided with an interface that allows the user to designate the return designation position by selecting a specific image. Such an interface is realized by recording the image and the moved route in a state where the timelines are synchronized as described above. Furthermore, in the interface, by designating a certain position of the moved route, an image corresponding to the designated position can be displayed. As a result, it is also possible to rewind and fast-forward the image being displayed by tracing the moved route on the interface. Note that the processing by the movement route recording unit (108, 205, 303) corresponds to an example of the processing of the movement route recording step.

### Information Processing Method

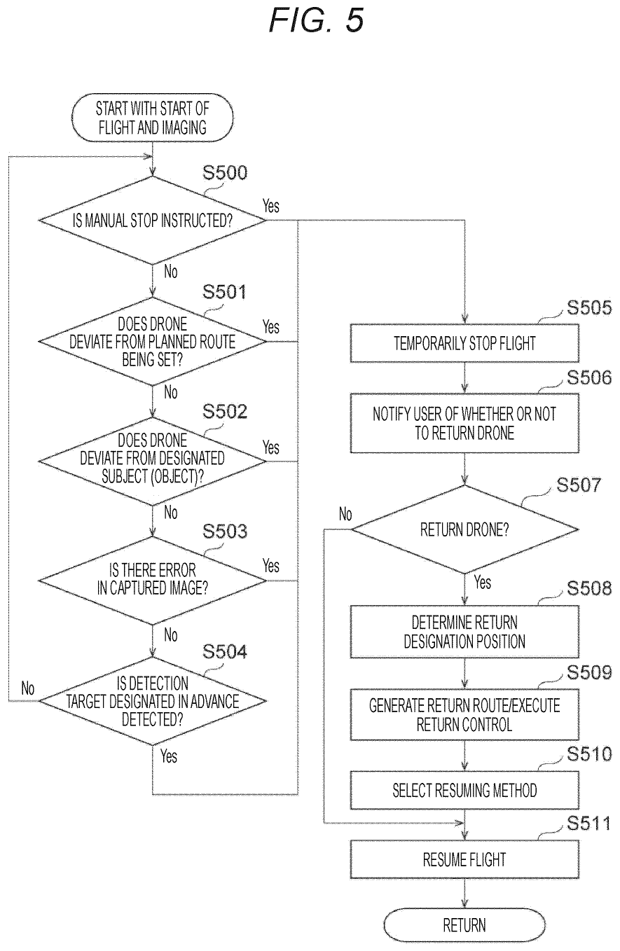

Next, an example of an information processing method performed by the information processing system S will be described with reference to the flowchart illustrated in FIG. 5. As an example, the process illustrated in FIG. 5 starts when the drone 10 starts flight and imaging according to a flight plan route for autonomous flight. However, the process illustrated in FIG. 5 can also be applied to a case where the drone 10 starts flight and imaging according to a flight plan route for automated flight and a case where the user starts imaging while flying the drone 10 by manual operation.

Furthermore, the process illustrated in FIG. 5 is performed between the drone 10 and the controller 20 as an example. However, the process described below can be executed only in the controller 20 or between the drone 10 and the cloud server 30.

After the process starts, first, in step S500, it is determined whether or not the user has manually instructed to temporarily stop the drone 10. In a case where the instruction of the temporary stop is not confirmed in step S500, the process proceeds to step S501. On the other hand, in a case where the instruction of the temporary stop is confirmed, the process proceeds to step S505, and the flight of the drone 10 is temporarily stopped.

In step S501, it is determined whether or not the drone 10 deviates from the set flight plan route by a predetermined distance or more. In a case where no deviation from the flight plan route is confirmed in step S501, the process proceeds to step S502. On the other hand, in a case where deviation from the flight plan route is confirmed, the process proceeds to step S505, and the flight of the drone 10 is temporarily stopped.

In step S502, it is determined whether or not the relative distance between the drone 10 and the object designated by the user, here, the subject designated to be imaged by the imaging device 12 is out of a predetermined condition. The user can designate that the flight of the drone 10 is performed such that the distance from the object such as the subject is maintained constant during the flight. In a case where such designation is performed, in step S502, it is detected that the designated state is no longer maintained. In a case where it is not confirmed in step S502 that the relative distance between the drone 10 and the subject is out of the predetermined condition, the process proceeds to step S503. On the other hand, in a case where it is confirmed that the relative distance is out of the predetermined condition, the process proceeds to step S505, and the flight of the drone 10 is temporarily stopped.

In step S503, it is determined whether or not an error has occurred in the image captured by the imaging device 12. As described above, the error of the image is, for example, a case where the image is not captured with an appropriate focus, a case where the image is not captured with an appropriate exposure, a case where the image is not appropriately captured, or the like. In a case where no image error is confirmed in step S503, the process proceeds to step S504. On the other hand, in a case where an error in the image is confirmed, the process proceeds to step S505, and the flight of the drone 10 is temporarily stopped.

In step S504, it is determined whether or not a detection target specified in advance exists in the image captured by the imaging device 12. As described above, the detection target is determined in advance by the user, and is, for example, rust, a scratch, or the like on a structure that is a subject being imaged. In a case where no image error is confirmed in step S503, the process returns to step S500. On the other hand, in a case where an error in the image is confirmed, the process proceeds to step S505, and the flight of the drone 10 is temporarily stopped.

In the present embodiment, the processing in steps S501 and S502 is performed by the movement control unit 109 in the drone 10, and the processing in steps S503 and S504 is performed by the image analysis unit 104 in the drone 10. However, the processing in steps S501 to S504 may be performed by the controller 20 or the cloud server 30. In this case, when the process proceeds from any of steps S501 to S504 to S505, a temporary stop command is transmitted from the controller 20 or the cloud server 30 to the drone 10.

The temporary stop of the flight of the drone 10 in step S505 is performed by the movement control unit 109.

Next, in step S506, a notification for prompting the user to return the drone 10 to a certain position is performed. In a case where the instruction of the temporary stop has been performed from the user in step S500 (in a case of “YES”), the occurrence of this instruction is provided to the notification unit 207. In a case where the occurrence of the predetermined event is detected in steps S501 to S504 (in a case of “YES”), information indicating the occurrence of the predetermined event is transmitted from the drone 10 to the controller 20 and provided to the notification unit 207. Then, the notification processing in step S506 is performed by the notification unit 207 with reception of information indicating the occurrence of the instruction or the occurrence of the predetermined event by the notification unit 207 as a trigger. The notification processing in step S506 is performed, for example, by displaying a warning on the display 21 as described above.

Next, in step S507, it is determined whether or not the user has given an instruction to return the drone 10. Whether or not the user has given an instruction to return the drone 10 is determined by whether or not the command reception unit 211 in the route planning unit 206 of the drone 10 has been provided with a command and information for generating a return route from the input unit 202 in response to an operation by the user.

The information for generating the return route with which the command reception unit 211 is provided includes information on the return designation position designated by the user, which is the return destination of the drone 10 from the current position. In the present embodiment, as described above, the interface that displays the moved route recorded in the movement route recording unit 205 in superimposition with the map image and allows the user to designate the return designation position from the moved route, and the interface that displays the image recorded in the image recording unit 204 so that the image can be rewound and fast-forwarded and allows the user to designate the return designation position by selecting a specific image are provided on the display 21.

In the present embodiment, for example, when the user designates the return designation position by the two interfaces, an instruction to designate the return designation position and to generate the return route is generated and provided to the command reception unit 211. As a result, it is confirmed in step S507 that the user has given an instruction to return the drone 10, and the process proceeds to step S508.

On the other hand, in the present embodiment, as an example, a cursor that generates an instruction to resume the movement without performing the operation to return the drone 10 is displayed on the display 21 together with the provision of the above-described two interfaces, and in a case where the cursor is operated, it is determined that the user does not desire to return the drone 10 (“NO” in step S507). In this case, the process proceeds to step S511, and the drone 10 resumes the flight according to the flight plan route. Thereafter, the process returns to step S500.

Then, in step S508 after the instruction to return the drone 10 is confirmed in step S507, the return designation position designated by the user is determined. In the determination of the return designation position, in a case where the user selects a certain point from the moved route displayed to be superimposed on the map image and designates the return designation position, the position corresponding to the point selected by the user is determined to be the return designation position. Furthermore, in a case where the user designates the return designation position by selecting a specific image, the position on the moved route where the designated image is captured is determined to be the return designation position. The processing of step S508 is processing corresponding to an example of the return designation position determination step.

Next, in step S509, the return route is generated by the return route generation unit 214 in the route planning unit 206. The return route generation unit 214 generates the return route on the basis of the portion from the return reference position to the return designation position in the moved route. That is, the generated return route is formed by a portion obtained by cutting out a part of the moved route. The return route is a route for causing the drone 10 to move a portion from the return reference position to the return designation position in the moved route. The generated return route is transmitted from the controller 20 to the drone 10. Then, the drone 10 is moved to the return designation position under the control of the movement control unit 109, The processing of step S509 is processing corresponding to an example of the return route generation step and the movement control step.

Thereafter, in step S510, the controller 20 confirms information regarding selection of the resuming method. Then, the return route generation unit 214 generates a return route for reference position according to the selected resuming method, and transmits the return route for reference position to the drone 10. In the present embodiment, after the drone 10 is moved to the return designation position as described above (after step S509), the command reception unit 211 receives an instruction to move the drone 10 to the return reference position. As a premise of the reception of this instruction, the return route generation unit 214 displays a plurality of candidates of return route patterns for reference position (that is, the resuming method) on the display 21. Then, the return route generation unit 214 generates a return route for reference position corresponding to the return route pattern for reference position selected by the user on the display 21 and transmits the return route for reference position to the drone 10.

Then, in step S511, the flight of the drone 10 is resumed. As described above, in a case where it is determined in step S507 that the user does not desire to return the drone 10, the drone 10 resumes the flight according to the flight plan route. On the other hand, in a case where the return route for reference position generated in step S510 is transmitted to the drone 10 and then the process proceeds to step S511, the drone 10 is moved to the return reference position according to the return route for reference position under the control of the movement control unit 109.

After the processing of step S511, when the drone 10 resumes the flight from the return reference position, the process returns to step S500. Note that the processing of steps S510 and S511 is processing corresponding to an example of the resuming step.

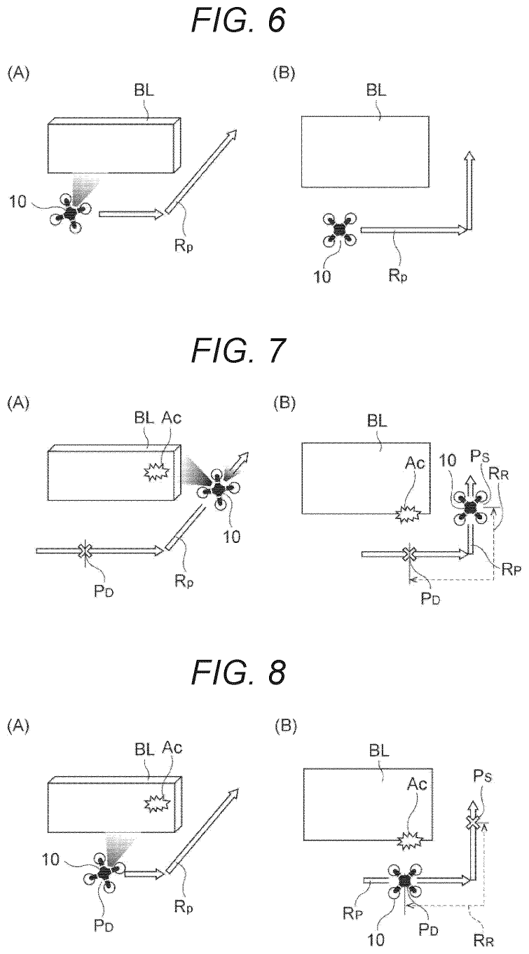

Hereinafter, an operation example of the drone 10 controlled by the information processing method described with reference to FIG. 5 will be specifically described with reference to FIGS. 6 to 17. (A) of FIGS. 6 to 8 is a bird's-eye view of an operation state of the drone 10, and (B) is a view of the operation state of the drone 10 as viewed from above.

FIG. 6 illustrates how the drone 10 flies according to a predetermined flight plan route Rp. In this example, a state is illustrated in which the drone 10 flies around a building BL according to the flight plan route Rp and inspects a defect in the building BL.

Although only a part of the flight plan route Rp in FIG. 6 is illustrated, FIG. 6 illustrates a part of the flight plan route Rp for moving the drone 10 from the front surface to the side surface of the building BL.

During the flight illustrated in FIG. 6, the processing in steps S501 to S504 in FIG. 5 is repeatedly performed. Then, FIG. 7 illustrates a state in which a predetermined state is detected in any processing of steps S501 to S504 and the flight of the drone 10 is temporarily stopped. FIG. 7 illustrates, as an example, a state in which a defect Ac as a detection target is detected in step S504 in an image captured by the imaging device 12.

Then, as illustrated in FIG. 7, in a state where the flight of the drone 10 is temporarily stopped, a notification for prompting the user to return the drone 10 is performed (step S506). Then, in this example, when the user designates a return designation position PD, a return route R_{R} indicated by a broken line in FIG. 7(B) is generated. The return route R_{R} is generated from a return reference position P_{S}, the return designation position P_{D}, and the moved route recorded in the movement route recording unit 205. The return reference position P_{S} is specified from the current position of the drone 10.

Then, FIG. 8 illustrates a state in which the drone 10 moves to the return reference position Ps according to the return route R_{R}. At this time, the drone 10 moves backward according to a part of the route actually traveled.

Furthermore, as described above, the image recorded in the image recording unit 204 is associated with the position on the moved route where the image is captured. Then, the recorded image and the angle information of the gimbal 12A when the image is captured are recorded in the image recording unit 204. Therefore, when the return reference position P_{S} is specified, the angle information of the gimbal 12A corresponding to the return reference position P_{S} is also specified. Then, when the drone 10 moves to the return reference position P_{S}, the gimbal 12A is controlled to match the angle information of the gimbal 12A corresponding to the return reference position P_{S}. As a result, when the drone 10 moves to the return reference position P_{S}, the range in which the defect Ac occurs can be accurately imaged by the imaging device 12.

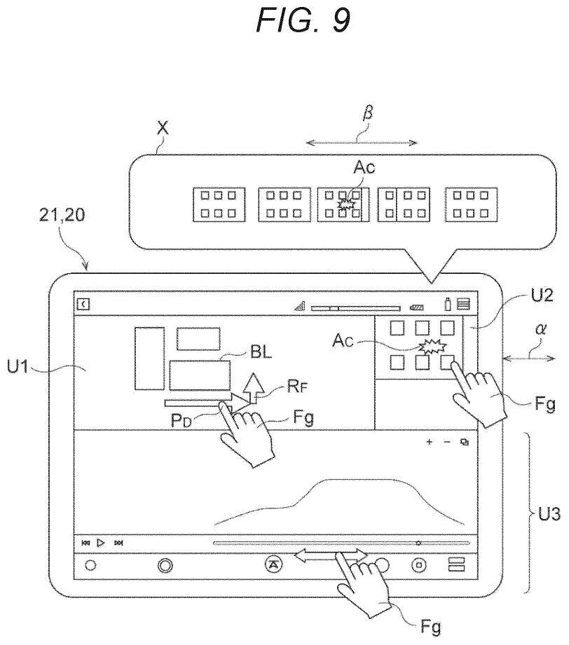

Here, FIG. 9 illustrates a specific example of an interface used by the user to designate the above-described “return designation position”. In FIG. 9, a first interface U1, a second interface U2, and a third interface U3 are illustrated on the display 21.

The first interface U1 is an interface that displays the moved route recorded in the movement route recording unit 205 so as to be superimposed on the map image, and allows the user to designate the return designation position from the moved route. FIG. 9 illustrates a moved route R_{F} when the drone 10 flies around the building BL illustrated in FIGS. 6 to 8. The first interface U1 is displayed on the display 21 when the drone 10 is temporarily stopped by a user's instruction or when a predetermined state is detected in steps S501 to S504 described above.

In the first interface U1, the user can specify the return designation position by touching any position on the displayed moved route R_{F} with, for example, a finger Fg. FIG. 9 illustrates a state in which the return designation position P_{D} described above is designated by the user. Note that, in the first interface U1, in a case where the predetermined state is detected in steps S501 to S504 described above, the position on the moved route R_{F} where the predetermined state is detected may be displayed in a mode different from other positions.

The second interface U2 is an interface that displays the image recorded in the image recording unit 204 so that the image can be rewound and fast-forwarded, and allows the user to designate the return designation position by selecting a specific image. In the second interface U2, when the user performs, for example, a flick operation with the finger Fg in the direction indicated by an arrow α, the display of a plurality of recorded images indicated in a range X is switched in the direction of an arrow β for convenience of description. Then, in this example, an image is selected by the user touching the image with, for example, the finger Fg in a state where a specific image is displayed. Then, by selecting the image in this manner, the return designation position is determined on the basis of the image.

The third interface U3 is an interface that displays the current position (traveling direction, latitude, longitude, altitude) of the drone 10 as a numerical value, a graph, or the like. Furthermore, the third interface U3 also includes an operation component for rewinding and fast-forwarding the image displayed on the second interface U2. As a result, the user can rewind and fast-forward the image displayed on the second interface U2 by operating the third interface U3 with the finger Fg, for example.

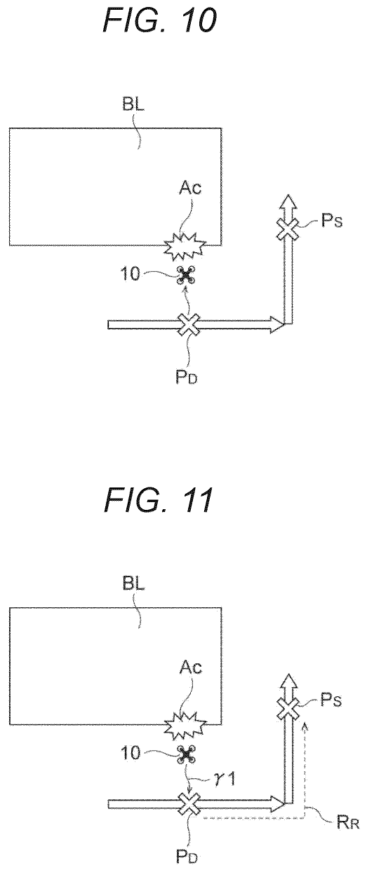

FIG. 10 illustrates a state in which the drone 10 is brought close to the defect Ac from the state of FIG. 8 to acquire a detailed image of the defect Ac. After moving the drone 10 to the return designation position P_{D} according to the return route R_{R} as described above, the user may optionally operate the drone 10 to move the drone 10 to a position deviated from the moved route. On the other hand, after the drone 10 is moved from the return designation position P_{D}, a situation occurs in which it is desired to return the drone 10 to the original flight plan route Rp. Here, in the present embodiment, as described above, an instruction to move the drone 10 to the return reference position is received. Then, as a premise of the reception of this instruction, the return route generation unit 214 displays a plurality of candidates of return route patterns for reference position (that is, the resuming method) on the display 21. Then, the return route generation unit 214 generates a return route for reference position corresponding to the return route pattern for reference position selected by the user on the display 21 and transmits the return route for reference position to the drone 10. Thereafter, the drone 10 resumes the flight according to the flight plan route Rp.

Each of FIGS. 11 to 14 illustrates a state in which the drone 10 in the state illustrated in FIG. 10 is moved to a flight plan route Rp as a predetermined route.

FIG. 11 illustrates a return route pattern for reference position in which the drone 10 is moved to the return designation position P_{D} and then moved to the return reference position P_{S} along the generated return route R_{R}.

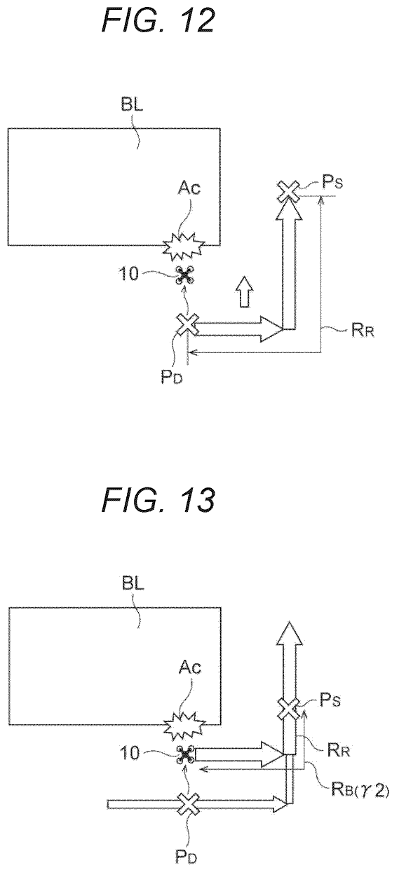

FIGS. 12 and 13 each illustrate a return route pattern for reference position in which a new return route for reference position R_{B} is generated by changing (offsetting) the position of the generated return route R_{R} (see FIG. 13) and the drone 10 is moved to the return reference position P_{S} along the return route for reference position R_{B}.

As illustrated in FIGS. 12 to 13, the return route for reference position R_{B} illustrated in FIG. 13 is generated by moving (offsetting) the return route R_{R} from the original position such that the return route R_{R} intersects the return reference position P_{S} while matching the upstream end of the generated return route R_{R} with the current position of the drone 10 deviated from the moved route R_{F}.

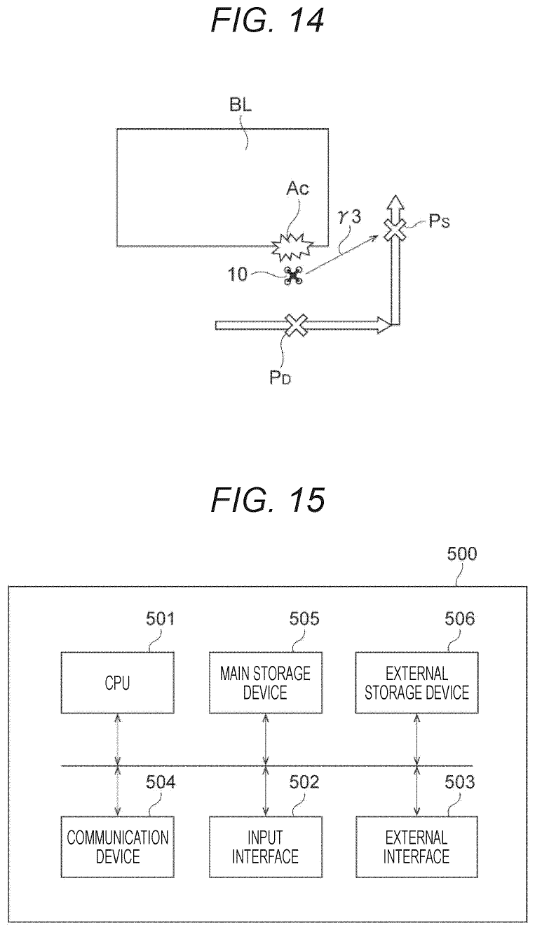

FIG. 14 illustrates a return route pattern for reference position for linearly moving the drone 10 to the return reference position P_{S} that is a reference when the return route R_{R} is generated.

For example, after the drone 10 is moved from the return designation position P_{D}, an arrow γ1 illustrated in FIG. 11, an arrow γ2 illustrated in FIG. 13, and an arrow γ3 illustrated in FIG. 14 may be displayed on the display 21 as a plurality of candidates of return route patterns for reference position (that is, the resuming method) according to a predetermined operation to prompt the user to select the return route pattern for reference position. Providing such an interface facilitates the operation to resume flight.

In the information processing system S according to the present embodiment described above, the movement route recording step of recording the moved route until the drone 10 reaches the current position, the return designation position determination step of determining the return designation position between the start point of the moved route and the current position of the drone 10, and the return route generation step of setting the current position of the drone 10 in the moved route as the return reference position and generating the return route for causing the drone 10 to move the portion from the return reference position to the return designation position in the moved route to the drone 10 are performed.

As a result, the drone 10 moved to a certain position can be easily and accurately returned to a desired position, and can be safely returned. That is, according to the steps described above, the drone 10 can be returned to the return designation position as a desired position located at upstream of the current position by an operation of only specifying the return designation position. Therefore, the operation to return the drone 10 does not take time and effort, and the target position (return designation position) is clearly specified, so that the drone 10 can be accurately moved to the return designation position. Then, the return route for returning the drone 10 to the return designation position includes the route on which the drone 10 has already moved. Therefore, since the return route is a route on which the drone 10 has already safely flown without contacting an obstacle or the like, the drone 10 can be safely moved to the return designation position. Therefore, the drone 10 can be easily and accurately returned to a desired position, and can be safely returned.

Furthermore, in the present embodiment, the return designation position described above can be determined from the position designated on the moved route displayed on the map image. Furthermore, any one of a plurality of recorded images is selected, and the position on the moved route where the selected image is captured can be determined as the return designation position. As a result, the user can easily operate when returning the drone 10 to a desired position, and convenience can be improved.

Furthermore, in the present embodiment, in a case where the drone 10 moving according to a predetermined flight plan route deviates from the flight plan route by a predetermined distance or more, a notification for prompting designation of the return designation position is performed. In addition, in a case where the relative distance between the drone 10 and a predetermined subject (object) is out of a predetermined range, a notification for prompting designation of the return designation position is performed. In addition, in a case where an image that does not satisfy a predetermined imaging condition is generated, a notification for prompting designation of the return designation position is performed. In addition, in a case where a predetermined detection target is detected, a notification for prompting designation of the return designation position is performed. By performing the notification as described above, it is possible to appropriately perform operations such as imaging and flight scheduled to be performed by the drone 10, and convenience can be improved. For example, the accuracy of inspection by the drone 10 can be improved.

Furthermore, in the present embodiment, in a situation where the drone 10 is moved to the return designation position and then the drone 10 is moved to a position deviated from the moved route, when the drone 10 is moved to the return reference position, the drone 10 can be moved to the return reference position along the return route after being moved to the return designation position as illustrated in FIG. 11 according to an instruction of the user. In addition, as illustrated in FIGS. 12 and 13, the return route is moved such that the return route intersects the return reference position while matching the upstream end of the return route with the position of the drone 10 deviated from the moved route, whereby the return route for reference position is generated, and the drone 10 can be moved to the return reference position along the return route for reference position. In addition, as illustrated in FIG. 14, the drone 10 can be linearly moved to the return reference position. As a result, it is possible to easily resume an initially scheduled operation such as imaging or flight interrupted by movement to the return designation position, and convenience can be improved.

### Hardware Configuration

FIG. 15 illustrates an example of a hardware configuration of the drone 10 and the controller 20 as the information processing device. The drone 10 and the controller 20 can be configured by a computer device 500 as illustrated in FIG. 15. The computer device 500 includes a CPU 501, an input interface 502, an external interface 503, a communication device 504, a main storage device 505, and an external storage device 506, which are interconnected to each other via a bus. At least one of these components may not be included in the drone 10 and the controller 20.

The central processing unit (CPU) 501 executes a computer program on the main storage device 505. The computer program is, for example, a program that implements each of the above-described functional configurations of the drone 10. The computer program may be implemented by a combination of a plurality of programs and scripts, instead of one program. The CPU 501 executes the computer program, to implement each of the functional configurations.

The input interface 502 is a circuit for inputting, to the drone 10 and the controller 20, an operation signal from an input device such as a keyboard, a mouse, and a touch panel.

The external interface 503 displays, on a display device, data stored in the drone 10 and the controller 20 or data calculated by the drone 10 and the controller 20, for example. The external interface 503 may be connected to a liquid crystal display (LCD), an organic electroluminescence display, or a plasma display (PDP), for example.

The communication device 504 is a circuit for the drone 10 and the controller 20 to communicate with an external device by wire or wirelessly. Data used in the drone 10 and the controller 20 can be input from the external device via the communication device 504. The communication device 504 may include an antenna. Data input from the external device can be stored in the main storage device 505 or the external storage device 506. The communication device 504 may be connected to another communication device such as a smartphone or a tablet in a wired or wireless manner.

The main storage device 505 stores data necessary for executing the computer program, data generated as a result of execution of the computer program, and the like. The computer program is deployed and executed on the main storage device 505. The main storage device 505 is, for example, a RAM, a DRAM, or an SRAM, but is not limited thereto. A storage unit for information and data in the communication device 504 may be constructed on the main storage device 505.

The external storage device 506 stores data necessary for executing the computer program, data generated as a result of execution of the computer program, and the like. The computer program and the data are read into the main storage device 505 when the computer program is executed. The external storage device 506 is, for example, a hard disk, an optical disk, a flash memory, and a magnetic tape, but is not limited thereto.

Note that the computer program may be installed in the computer device 500 in advance or may be stored in a storage medium such as a CD-ROM. Alternatively, the computer program may be uploaded on the Internet.

Furthermore, the computer device 500 may be configured as a single device, or may be configured as a system including a plurality of computer devices connected to each other.

Note that the embodiment described above represents an example for embodying the present disclosure, and the present disclosure can be implemented in various other modes. For example, various modifications, replacements, omissions, or combinations thereof can be made without departing from the gist of the present disclosure. Forms in which such modifications, replacements, omissions, and the like have been made are also included in the scope of the present disclosure and are likewise included in the invention described in the claims and the equivalent scopes thereof.

For example, in the above-described embodiment, an example of a drone that is an unmanned flying object has been described as an example of the moving body. However, the technique of the present disclosure can also be applied to an underwater drone, and the like.

Furthermore, the effects of the present disclosure described in the present specification are merely an example, and other effects may be achieved.

Note that, the present disclosure can also have the following configurations.

### [Item 1]

An information processing method including:
a movement route recording step of recording a moved route until a moving body reaches a current position;
a return designation position determination step of determining a return designation position between a start point of the moved route and the current position of the moving body; and
a return route generation step of setting the current position of the moving body in the moved route as a return reference position and generating a return route for causing the moving body to move a portion from the return reference position to the return designation position in the moved route.

### [Item 2]

The information processing method according to [1], further including a return movement control step of moving the moving body from the return reference position to the return designation position according to the return route.

### [Item 3]

The information processing method according to [1] or [2], in which in the return designation position determination step, a position designated on the moved route displayed on a map image is determined to be the return designation position.

### [Item 4]

The information processing method according to any one of [1] to [3], further including an image recording step of recording a plurality of images continuously captured by the moving body when the moving body moves along the moved route, in which
in the return designation position determination step, any one of the plurality of images recorded in the image recording step is selected, and a position on the moved route where the selected image is captured is determined to be the return designation position.

### [Item 5]

The information processing method according to any one of [1] to [4], further including a resuming step of moving the moving body to the return designation position and then moving the moving body to the return reference position along the return route when the moving body is moved to the return reference position in a situation where the moving body has moved to a position deviated from the moved route after being moved to the return designation position.

### [Item 6]

The information processing method according to any one of [1] to [5], further including a resuming step of generating a return route for reference position by moving the return route such that the return route intersects with the return reference position while matching an upstream end of the return route with a position of the moving body deviated from the moved route when the moving body is moved to the return reference position in a situation where the moving body has moved to a position deviated from the moved route after being moved to the return designation position, and moving the moving body to the return reference position along the return route for reference position.

### [Item 7]

The information processing method according to any one of [1] to [6], further including a resuming step of linearly moving the moving body to the return reference position when the moving body is moved to the return reference position in a situation where the moving body has moved to a position deviated from the moved route after being moved to the return designation position.

### [Item 8]

The information processing method according to any one of [1] to [7], further including a notification step of performing a notification for prompting designation of the return designation position in a case where the moving body moving along a predetermined planned route deviates from the planned route by a predetermined distance or more.

### [Item 9]

The information processing method according to any one of [1] to [8], further including a notification step of performing a notification for prompting designation of the return designation position in a case where a relative distance between the moving body and a predetermined target object around the moving body is out of a predetermined range while the moving body is moving so that the relative distance falls within the predetermined range.

### [Item 10]

The information processing method according to any one of [1] to [9], further including a notification step of performing a notification for prompting designation of the return designation position in a case where an image not satisfying a predetermined imaging condition is generated in a plurality of images continuously captured by the moving body while the moving body is moving.

### [Item 11]

The information processing method according to any one of [1] to [10], further including a notification step of performing a notification for prompting designation of the return designation position in a case where a predetermined detection target is detected in a plurality of images continuously captured by the moving body while the moving body is moving.

### [Item 12]

An information processing device including:
a movement route recording unit of recording a moved route until a moving body reaches a current position;
return designation position determination unit of determining a return designation position between a start point of the moved route and the current position of the moving body; and
a return route generation unit of setting the current position of the moving body in the moved route as a return reference position and generating a return route for causing the moving body to move a portion from the return reference position to the return designation position in the moved route.

### [Item 13]

A computer program for causing a computer to execute:
a movement route recording step of recording a moved route until a moving body reaches a current position;
a return designation position determination step of determining a return designation position between a start point of the moved route and the current position of the moving body; and
a return route generation step of setting the current position of the moving body in the moved route as a return reference position and generating a return route for causing the moving body to move a portion from the return reference position to the return designation position in the moved route.

### REFERENCE SIGNS LIST

S Information processing system
10 Drone (moving body)
11 Airframe
12 Imaging device
12A Gimbal
13 Motor
14 Propeller
101 Communication unit
102 Gimbal imaging control unit
103 Image recording unit
104 Image analysis unit
105 Self-position recognition unit
106 Distance measurement unit
107 Obstacle recognition unit
108 Movement route recording unit
109 Movement control unit
20 Controller
20′ Tablet
20″ Personal computer
21 Display
201 Communication unit
202 Input unit
203 Display unit
204 Image recording unit
205 Movement route recording unit
206 Route planning unit
207 Notification unit
211 Command reception unit
212 Automated autonomous route generation unit
213 Return designation position determination unit
214 Return route generation unit
30 Cloud server
301 Communication unit
302 Image recording unit
303 Movement route recording unit
304 Image analysis unit
40 Base station
U1 First interface
U2 Second interface
U3 Third interface
P_{S} Return reference position
P_{D} Return designation position
R_{R} Return route
R_{F} Moved route
R_{B} Return route for reference position

1. An information processing method comprising:
a movement route recording step of recording a moved route until a moving body reaches a current position;
a return designation position determination step of determining a return designation position between a start point of the moved route and the current position of the moving body; and
a return route generation step of setting the Current position of the moving body in the moved route as a return reference position and generating a return route for causing the moving body to move a portion from the return reference position to the return designation position in the moved route.

2. The information processing method according to claim 1, further comprising a return movement control step of moving the moving body from the return reference position to the return designation position according to the return route.

3. The information processing method according to claim 1, wherein in the return designation position determination step, a position designated on the moved route displayed on a map image is determined to be the return designation position.

4. The information processing method according to claim 1, further comprising an image recording step of recording a plurality of images continuously captured by the moving body when the moving body moves along the moved route, wherein
in the return designation position determination step, any one of the plurality of images recorded in the image recording step is selected, and a position on the moved route where the selected image is captured is determined to be the return designation position.

5. The information processing method according to claim 1, further comprising a resuming step of moving the moving body to the return designation position and then moving the moving body to the return reference position along the return route when the moving body is moved to the return reference position in a situation where the moving body has moved to a position deviated from the moved route after being moved to the return designation position.

6. The information processing method according to claim 1, further comprising a resuming step of generating a return route for reference position by moving the return route such that the return route intersects with the return reference position while matching an upstream end of the return route with a position of the moving body deviated from the moved route when the moving body is moved to the return reference position in a situation where the moving body has moved to a position deviated from the moved route after being moved to the return designation position, and moving the moving body to the return reference position along the return route for reference position.

7. The information processing method according to claim 1, further comprising a resuming step of linearly moving the moving body to the return reference position when the moving body is moved to the return reference position in a situation where the moving body has moved to a position deviated from the moved route after being moved to the return designation position.

8. The information processing method according to claim 1, further comprising a notification step of performing a notification for prompting designation of the return designation position in a case where the moving body moving along a predetermined planned route deviates from the planned route by a predetermined distance or more.

9. The information processing method according to claim 1, further comprising a notification step of performing a notification for prompting designation of the return designation position in a case where a relative distance between the moving body and a predetermined target object around the moving body is out of a predetermined range while the moving body is moving so that the relative distance falls within the predetermined range.

10. The information processing method according to claim 1, further comprising a notification step of performing a notification for prompting designation of the return designation position in a case where an image not satisfying a predetermined imaging condition is generated in a plurality of images continuously captured by the moving body while the moving body is moving.

11. The information processing method according to claim 1, further comprising a notification step of performing a notification for prompting designation of the return designation position in a case where a predetermined detection target is detected in a plurality of images continuously captured by the moving body while the moving body is moving.

12. An information processing device comprising:
a movement route recording unit of recording a moved route until a moving body reaches a current position;
a return designation position determination unit of determining a return designation position between a start point of the moved route and the current position of the moving body; and
a return route generation unit of setting the current position of the moving body in the moved route as a return reference position and generating a return route for causing the moving body to move a portion from the return reference position to the return designation position in the moved route.

13. A computer program for causing a computer to execute:
a movement route recording step of recording a moved route until a moving body reaches a current position;
a return designation position determination step of determining a return designation position between a start point of the moved route and the current position of the moving body; and
a return route generation step of setting the current position of the moving body in the moved route as a return reference position and generating a return route for causing the moving body to move a portion from the return reference position to the return designation position in the moved route.
